(19) United States
(12) Patent Application Publication
(10) Pub. No.: US 2025/0243431 A1
(43) Pub. Date: Jul. 31, 2025

(54) DETERGENT COMPOSITION FOR INTERNAL PARTS OF VEHICLES

(71) Applicant: MA-FRA S.P.A., Baranzate (MI) (IT)

(72) Inventor: Marco Mattioli, Baranzate (MI) (IT)

(73) Assignee: MA-FRA S.P.A., Baranzate (MI) (IT)

(21) Appl. No.: 18/700,010

(22) PCT Filed: Oct. 11, 2022
(86) PCT No.: PCT/EP2022/078185

§ 371 Date: Apr. 10, 2024

(30) Foreign Application Priority Data
Oct. 12, 2021 (IT) 102021000026108

(51) Int. Cl. C11D 3/20; B08B 1/12; B08B 3/08; B08B 3/10; B60S 3/00

(52) U.S. Cl. CPC C11D 3/2086; B08B 1/12; B08B 3/08; B08B 3/10; B60S 3/008

(57) ABSTRACT

An aqueous composition for the cleaning and/or stain removal of the plastic and fabric surfaces of the internal parts of vehicles, i.e. cars, motor vehicles, trucks, buses, lorries, railway carriages and other means of locomotion on rails, both public and private, is described herein. The use of this composition and a complete washing and/or stain removal process which includes the use of such composition is also described.

### TECHNICAL FIELD OF THE INVENTION

The present invention relates to an aqueous composition for the cleaning and/or stain removal of the plastic and fabric surfaces of the interior parts of vehicles, i.e. cars, motor vehicles, trucks, buses, lorries, railway carriages and other means of locomotion on rails, both public and private.

### BACKGROUND OF THE INVENTION

In the market segment concerning the cleaning and care of fabric seats, mats, metal parts and interior plastics of vehicles, such as cars, lorries, car wagons, buses and in general vehicles used for public and private transport, including means of locomotion on rails, an immediate identification and subsequent removal of spots hidden or invisible to the human eye is especially relevant, in particular, those made up of inorganic residues, such as limestone, minerals, dust or organic residues, such as sweat and mixed dirt stains, and the use of cleaning products dedicated to this purpose.

Currently, the market for vehicle interior care products is made up of alkaline formulations (pH>7) that do not allow complete cleaning of the passenger compartment. A very common problem that occurs, when caring for vehicle interiors, it is in fact the presence of inorganic stains treated with alkaline detergents, which become visible once the fabric is dried. When this happens, it is necessary to repeat the treatment, for example of a seat, causing the product to penetrate into the deeper layers of the fabric and thus making the washing and drying phase difficult and consequently lengthening the working times.

Furthermore, on the plastic supports, the common alkaline detergents besides not removing inorganic residues, they tend to fade the surface and often leave an uneven finish and surface halos. An effective treatment should instead give to the treated fabric a final aspect more pleasing to the eye, an impression of renewal effect of the colour of the fibre and a natural and streak-free surface finish, as well as quick rinsing and subsequent drying of the treated supports. Patent application DE19511193 reports a process for cleaning carpets, in which the aqueous cleaning liquid used, as the essential cleaning active ingredient, comprises an alkali metal salt of a polycarboxylic acid or of a hydroxycarboxylic acid having 2 to 12 carbon atoms and the weight ratio of this alkali metal salt to surfactant optionally contained in the cleaning solution is at least 2:1. Examples of such carboxylic acids are succinic acid, glutaric acid, adipic acid, butanetricarboxylic acid, butanetetracarboxylic acid, the tri-, tetra-, penta-and hexacarboxylic acids of benzene and of cyclohexane, maleic acid, fumaric acid, glycolic acid, lactic acid, malic acid, gluconic acid, citric acid and O-carboxymethyltartronic acid. The alkali metal salts of gluconic acid and of citric acid are preferably used, of which alkali metal citrate is in turn particularly preferred. Preferably, the cleaning liquid used in the method according to the invention has a pH between about 3 and about 12, in particular between about 5 and about 9.

### DESCRIPTION OF THE INVENTION

The object of the present invention is therefore to obtain a water-based formulation with acid pH, preferably at a pH<3, for the cleaning and care of fabrics and internal plastics of vehicles, which solves the problems mentioned above and at the same time reduces the user's working and drying times. The object of the invention is also the development of a specific treatment procedure for the complete and total cleaning of vehicle interiors.

In particular, the present acid composition comprises the following acid components: glycolic acid (CAS: 79-14-1) and lactic acid (CAS: 79-33-4).

The main object of the present invention is, therefore, an aqueous composition comprising glycolic acid and lactic acid for the cleaning and/or stain removal of the plastic and fabric surfaces of the interior parts of vehicles.

According to an aspect of the invention, the composition further comprises non-ionic surfactants, cationic surfactants, emulsifiers, sequestering agents, dyes and perfumes.

According to an aspect of the present invention, the glycolic acid is present in amounts comprised between 0.1% and 5% in weight and the lactic acid is present in amounts comprised between 0.1% and 5% in weight:

The vehicles, the internal parts of which can be treated with the composition of the invention, are selected from among cars, motor vehicles, lorries, buses, trucks, railway carriages and other public and private means of locomotion on rails.

In general, an excessive concentration (higher than the values indicated) of the two acids can damage the fabric fibers and cause an excessive deposit of residue, which can only be eliminated with repeated washing, thus lengthening the washing times and canceling one of the advantages of the composition of the invention.

On the other hand, a concentration too low (lower than the indicated values) of the two acids gives rise to a composition, which is not as effective as the composition of the invention.

The composition of the invention is particularly suitable for the cleaning and/or removal of inorganic stains by means of both manual and automatic dispensing and washing systems and can be used in combination with alkaline products (pH>7) or as a special pre-treatment for a complete washing, which will be described later.

The use of the composition of the invention results in a visual effect that is not achievable with common alkaline detergents on the market. The organic acidic nature of the active ingredients is in fact extremely compatible with the fibres of the fabric, which, once freed from inorganic residues, are renewed in their colouring.

The surfaces and plastic supports treated with the composition are similarly renewed in the visual aspect. The resulting finish is natural and is not altered by the active ingredients contained. Furthermore, no surface residues are observed, which often occur due to excessive use of the product and a failure to identify the stains existing with the products normally marketed. In fact, immediately after its application on the surface to be treated, the composition acts as a highlighter for spots that are often not very visible to the eye, thus facilitating the user's work. The effect, called “Luminol™ effect”, is produced by the reaction of the two active ingredients and the co-formulants contained that interact with the dirtiness present on the surfaces, forming a momentary active foam that is immediately perceptible to the eye. This effect of the present composition is illustrated in FIGS. 1 and 2. FIG. 3 shows the final result following washing with the composition of the invention.

FIGS. 1 and 2 show how the composition of the present invention is able to highlight the part of the surface containing dirt residues.

Specifically, the “Luminol™ effect” occurs through a reaction with mixed inorganic residues deriving from external climatic conditions (e.g.: rain), sweat stains or dirt transported inside the vehicle and which incorporate a mixture of powders and salts such as carbonates, silicates and limestone residues in general.

An example of the reaction between glycolic acid and the inorganic sodium carbonate salt present on the surface to be treated is shown below.

2CH₂OHCOOH+Na₂CO₃→2CH₂OHCOONa+H₂O+CO₂

Glycolic acid reacts slowly with sodium carbonate, thus favouring the constant formation of carbon dioxide, which, together with the co-formulants contained (surfactants and sequestering agents), produces a significant and visible effect to the user (Luminol™ effect).

Specifically, the formation of carbon dioxide that develops from the reaction described above allows the composition to remain in the surface layer of the permeable fabric, favouring an optimal treatment of the stain and a swift and effective removal of residues and drying. The other products of the reaction are water and water-soluble salts, which are easily removed with a simple damp cloth or a normal household wet vacuum cleaner without the need to use specific and professional equipment. Moreover, it is not necessary to rinse or wash the fabric, thus avoiding having to wait long drying times.

Furthermore, by using the composition of the invention, any pre-treatment of the stains before washing is no longer necessary, thus eliminating a processing step.

Normally, for a vehicle interior one washing cycle, the work time estimated by professional operators is about 3 hours. With the use of this composition, together with the lack of pre-treatment and rapid drying, the working time is halved.

The composition has been tested by professionals in the sector to develop a new complete cleaning process for the interior seats, which is described in detail here.

The process comprises for example the following steps:
dilution of the composition with 5 parts of water (1 part of product: 5 parts of water);
dispensing of the diluted product on the support to be treated;
brushing of the entire surface, on which the product has been applied;
waiting time for reaction of an average time between 5 and 15 minutes;
optionally, subsequent dispensing of an alkaline product (#Ductile™) diluted with 10 parts of water;
removal of superficial excess with a damp cloth or liquid suction equipment.

The method described herein is innovative as there is no similar procedure on the market that leads to complete care and cleaning of the supports to be treated (seats, plastics, general passenger compartment interior), which does not require pre-treatment and which halves the working time and drying. A cycle is then completed in 1.5 hours instead of 3 hours. Unless otherwise defined, all technical and scientific terms used here and below have the same meaning as commonly understood by a person with ordinary experience in the art, to which the present invention belongs.

Although methods and materials similar or equivalent to those described herein can be used in the practice and in the tests of the present invention, the methods and materials are described below as an example. The materials, methods and examples are for illustrative purposes only and are not intended to be restrictive.

As used in this specification and in the claims, the terms “comprising”, “containing” or “including” mean that at least the compound, element, material, co-formulant, or the method or the step, etc., indicated are present in the composition, in the formulation, or in the process, even if the presence of other compounds, elements, materials, excipients or steps of the method, etc., is not excluded and even if the other such compounds, elements, materials, excipients, or method, or steps, etc., have the same function as that which is indicated, unless there is an explicit exclusion in the claims. It is also to be understood that the mention of one or more steps of the method does not exclude the presence of further steps of the method before or after the recited combined procedure or intermediate steps of the method among those expressly identified.

### DESCRIPTION OF THE FIGURES

FIG. 1 shows a demonstration sequence highlighting the so called “Luminol™ effect”. The first photography from the left shows a dirty surface (of a fabric car seat) to be cleaned; in the second and third photos the composition of the invention is sprayed on this surface; the fourth photography shows how the composition acts as a highlighter for spots that were hardly visible to the eye before application, that is, in the first photography.

FIG. 2, like FIG. 1, shows a demonstrative sequence that highlights the so-called “Luminol™ effect”. The first photography from the left shows a dirty surface (of a seat in a fabric different from that of FIG. 1) to be cleaned; in the second and third photos the composition of the invention is sprayed on this surface; the fourth photography shows how the composition acts as a highlighter for spots that were hardly visible to the eye before application, that is, in the first photography.

FIG. 3 also shows a sequence demonstrating the effectiveness of the composition of the invention. The first photography from the left shows a dirty surface (of a fabric car seat) to be cleaned, while the second photography shows the surface at the end of the washing process with the composition of the invention. At the end of the process, the surface is clean and has a uniform colour without spots.

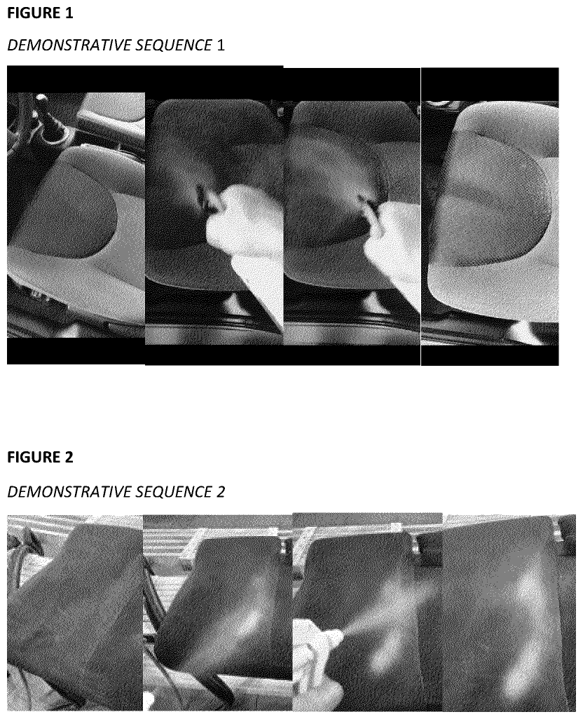

### EXAMPLES

### Example 1—Preparation of the Detergent Composition of the Present Invention The composition of the invention was prepared using the following raw materials:

| | |
|---|---|
| Inorganic acids (e.g. phosphoric acid, | <0.5% |
| hydrochloric acid, sulphuric acid) | |
| [Suppliers: BRENNTAG S.p.A., | |
| Rainoldi S.p.A., Torchiani S.R.L.] | |
| Alkyl polyglucosides C₈-C₁₆ | 2%-4% |
| [Suppliers: BASF ITALIA S.p.A., | |
| BRENNTAG S.p.A.] | |
| Quaternary ethoxylated C₁₂-C₁₄ alkyl | 1%-3% |
| methyl amine, methyl chloride | |
| [Supplier: Specialities S.R.L.] | |
| Glycolic acid | 2.8% |
| [Supplier: Garzanti Specialites S.p.A.] | |
| Lactic acid | 3.2% |
| [Supplier: Elettrochimica Valle Staffora S.p.A.] | |

Other components: sequestering agent {Glutamic acid, N,N-Diacetic acid, tetrasodium salt [supplied by BRENNTAG S.p.A.], perfume (SEA SHELL [supplied by GRC Parfum S.p.A.]}.

The preparation of the water-based composition occurred by sequential addition of the components respecting the solubilisation times and maintaining a constant stirring (rotor speed at 700 rpm). The only solvent used during preparation is water. Specifically, it was initially proceeded with the addition of the active ingredients in the solvent phase (water) and continued with the subsequent additions of the co-formulants listed above. The final preparation was clear and transparent.

### Comparative Example 1

Detergent compositions having different percentage compositions in glycolic acid and/or lactic acid were prepared. In particular, detergent compositions have been prepared having the following compositions:

| | Glycolic Acid | Lactic acid |
|---|---|---|
| Components | (% weight) | (% weight) |
| Composition A | 0.3 | 0.3 |
| Composition B | 1 | 0.3 |
| Composition C | 0.3 | 1 |

### Example 2—Complete Cleaning Process of the Interior Seats of the Passenger Compartment of a Car

The composition prepared according to Example 1 was diluted with 5 parts of water (1 part of composition: 5 parts of water). The resulting product was sprayed onto the surface of a fabric seat of a car to be washed and with stains to be removed. Subsequently, the entire surface, on which the product was applied, was brushed. The product was left to act for about 10 minutes. Subsequently, the alkaline product (#Ductile™) diluted with 10 parts of water was sprayed on the same surface. Finally, the surface excess was removed with equipment that sucks up liquids, for example, traditional dry steam equipment or Mafra Geyser steam/suction units.

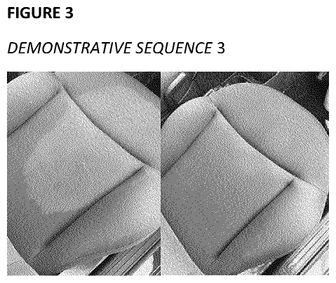

The surface turned out to be clean, having a uniform colour and without stains. FIG. 3 shows a demonstrative sequence of the effectiveness of the composition of the invention. The first photography from the left shows the dirty surface of the fabric seat before cleaning, while the second photo shows the surface at the end of the washing process with the composition of the invention. The surface at the end of the process is clean and has a uniform color and without stains, as can be seen from FIG. 3.

### Comparative Example 2

The compositions prepared according to the Comparative Example 1 were diluted with 5 parts of water (1 part of product: 5 parts of water). The resulting products were sprayed onto the surface of a fabric seat of a car to be washed and spot cleaned. Subsequently, the entire surface, on which the product was applied, was brushed. The product was left to act for about 10 minutes.

Subsequently, the alkaline product (#Ductile™) diluted with 10 parts of water was sprayed on the same surface. Finally, the surface product excess was removed with an equipment that sucks up liquids, for example, traditional dry steam equipment or Mafra Geyser steam/suction units. The surfaces treated with compositions A, B and C were not uniformly cleaned and some stains, although faded, were still visible.

1. An aqueous composition for the cleaning and/or stain removal of plastic and fabric surfaces of the interior parts of vehicles comprising glycolic acid and lactic acid, each in amounts comprised between 01% and 5% in weight.

2. The composition according to claim 1, having a pH lower than 3.

3. The composition according to claim 1, further comprising non-ionic surfactants, cationic surfactants, emulsifiers, sequestering agents, dyes and perfumes.

4. The composition according to claim 1, wherein the vehicles are selected between cars, motor vehicles, lorries, buses, road trains, railway carriages and other public or private means of locomotion on rails.

5. The composition according to claim 1, wherein the stain is inorganic.

6. The process according to claim 7, in manual, semi-automatic or automatic washing and drying systems.

7. Process for the cleaning and/or stain removal of plastic and fabric surfaces of the interior parts of vehicles, wherein the composition according to claim 1 is applied homogeneously or sprayed on said surfaces, which are subsequently left to dry or subjected to aspiration to eliminate any residues of said composition.

8. The process of claim 7, comprising the following steps:
diluting the composition according to claim 1 with five parts of water (1 part of composition: 5 parts of water);
dispensing the diluted composition on the surface to be treated;
brushing the surface, on which the composition has been applied;
waiting for reaction an average time between 5 and 15 minutes;
dispensing on the surface an alkaline product;
removing any superficial excess with a damp cloth or liquid suction equipment.

9. Process for the cleaning and/or stain removal of plastic and fabric surfaces of the interior parts of vehicles, wherein a water-based formulation with a pH lower than 3 is applied homogeneously or sprayed on said surfaces, which are subsequently left to dry or subjected to aspiration to eliminate any residues of said composition and subsequently treated with an alkaline product.
